(19) United States
(12) Patent Application Publication
(10) Pub. No.: US 2025/0005285 A1
(43) Pub. Date: Jan. 2, 2025

(54) AUTOMATIC GENERATION OF TREEBANK PARSE DATA FOR TRAINING CONSTITUENCY PARSERS

(71) Applicant: GRAMMARLY, INC., San Francisco, CA (US)

(72) Inventors: Justin Hugues-Nuger, San Francisco, CA (US); Gunnar Lund, Chicago, IL (US); Mark Norris, San Francisco, CA (US)

(21) Appl. No.: 18/758,194

(22) Filed: Jun. 28, 2024

Related U.S. Application Data
(60) Provisional application No. 63/511,022, filed on Jun. 29, 2023.

(51) Int. Cl. G06F 40/284; G06F 16/31; G06F 40/205; G06F 40/242

(52) U.S. Cl. CPC G06F 40/284; G06F 16/322; G06F 40/205; G06F 40/242

(57) ABSTRACT

In an embodiment, a computer-implemented method is executed using processors of a computer system, and includes accessing stored corpus data and tokenizing the corpus data into sequences of tokens; based on matching the sequences of tokens to a stored part-of-speech (POS) dictionary, generating a plurality of POS sequences; and accessing a first treebank data set and storing a plurality of parses from the first treebank data set in a tree data structure in a memory of the computing system. For each POS sequence, the method further includes, using the tree data structure, identifying candidate parses that matches that POS sequence; based on a stored lexical database, selecting a sentence corresponding to one candidate parse that is semantically similar to that POS sequence; substituting, in the one candidate parse, words from that POS sequence, to form an updated parse; and storing the updated parse in a second treebank data set.

### BENEFIT CLAIM

This application claims the benefit under 35 U.S.C. § 119(e) of provisional application 63/511,022, filed 29 Jun. 2023, the entire contents of which are incorporated herein by reference for all purposes as if fully set forth herein.

### TECHNICAL FIELD

One technical field of the present disclosure is computer-implemented techniques for training machine learning models, including large language models (LLMs). Another technical field is computer-assisted linguistic analysis of digitally stored text in human natural languages.

### BACKGROUND

The approaches described in this section are approaches that could be pursued but not necessarily approaches that have been previously conceived or pursued. Therefore, unless otherwise indicated, it should not be assumed that any of the approaches described in this section qualify as prior art merely by their inclusion in this section.

Automated language processing systems rely on a constituency parser for obtaining linguistically informed suggestions and correcting errors in the output of machine learning models. A constituency parser generally organizes digitally stored words of natural language text into nested constituents of a sentence, clause, phrase, or other natural language structure. In this manner, a constituency parser can create constituency trees, phrase structure trees, or parse trees. A constituent is a unit that can appear in different locations in a natural language phrase, clause, or sentence.

Constituency parsing can be implemented using a machine learning model trained on a large data set of parse trees, sometimes termed “parses” for short. Therefore, such data-driven constituency parsing requires training data. Typically, treebank data is used for training; the Penn Treebank (PTB) is an example of a known form of treebank data available in data sets of about 50,000 annotated sentences. Treebank data associates text for a sentence, clause, or phrase in a natural language with metadata describing the text in a sequential, tokenized format.

To support accurate language processing operations, treebank data must have a high level of annotation accuracy and must be present in a volume or quantity sufficient to train a high-accuracy machine learning model. Unfortunately, treebank data is difficult to obtain or create manually in high volume, and digital treebank datasets are scarce; the work involved in creating them makes them valuable. Manually creating parse trees cannot easily scale to the needs of artificial intelligence systems and is beyond human capacity when an input corpus contains millions of sentences that need to be accurately transformed into parse trees and would be highly error-prone. Consequently, the referenced technical fields have developed an acute need for better ways to obtain treebank data automatically.

### SUMMARY

The appended claims may serve as a summary of the invention.

### BRIEF DESCRIPTION OF THE DRAWINGS

In the drawings:

FIG. 1A illustrates a visual tree diagram.

FIG. 1B illustrates a distributed computer system showing the context of use and principal functional elements with which one embodiment could be implemented.

FIG. 2 illustrates a programmed data flow and distributed computer system, showing the context of use and principal functional elements with which one embodiment could be implemented.

FIGS. 3A and 3B illustrate a flow diagram of an example method for providing treebank data for a constituency parser and executing the training phase of the constituency parser.

FIG. 4 illustrates a computer system that could be used to implement aspects of one embodiment.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail set forth in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures. Such features are not limited to usage in one or more particular embodiments or figures with reference to which they are described. Thus, the present disclosure is neither a literal description of all embodiments of one or more inventions nor a listing of features of one or more of the inventions that must be present in all embodiments.

Headings of sections and the title are provided for convenience but are not intended to limit the disclosure in any way or as a basis for interpreting the claims. Devices that are described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or multiple manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

The disclosure is directed to persons having a high level of skill in linguistics, computer-assisted natural language processing, and the selection, configuration, training, testing, and evaluation of machine learning models that are used for natural language processing. The person of ordinary skill in the art to which this disclosure pertains typically will hold a Doctor of Philosophy (Ph.D.) degree in linguistics and significant to substantial computer science and computing coursework as applied to language analysis and processing or hold a Ph.D. in computational linguistics.

### 1. General Overview

Embodiments provide programmed, automatically operated methods to curate additional treebank data parsed automatically. In one embodiment, a computer-implemented method is programmed to map existing parses to new sentences using lexical information or knowledge from sources outside the program. One embodiment leverages a relatively small set of existing source parses, which are encoded in a structured, keyed, in-memory tree data structure to facilitate rapid lookups, as well as a set of world knowledge representing lexical information and new sentence data from a public corpus to form a basis of generating an arbitrary number of new, highly accurate parses. Using world knowledge and an efficient lookup structure for existing parse trees enabled the inventors to conceive of and/or discover a constituency-parsed data bootstrapper capable of automatically synthesizing a large quantity of treebank data. The approaches of the disclosure can generate an arbitrary amount of highly accurate treebank data useful in training a constituency parser.

In the following description, numerous specific details are outlined to provide a thorough understanding of the present invention. It will be apparent, however, that the present invention may be practiced without these specific details. In other instances, well-known structures and devices are shown in block diagram form to avoid unnecessarily obscuring the present invention.

The text of this disclosure, in combination with the drawing figures, is intended to state in prose the algorithms that are necessary to program the computer to implement the claimed inventions at the same level of detail that is used by people of skill in the arts to which this disclosure pertains to communicate with one another concerning functions to be programmed, inputs, transformations, outputs and other aspects of programming. That is, the level of detail outlined in this disclosure is the same level of detail that persons of skill in the art normally use to communicate with one another to express algorithms to be programmed or the structure and function of programs to implement the inventions claimed herein.

This disclosure may describe one or more different inventions, with alternative embodiments to illustrate examples. Other embodiments may be utilized, and structural, logical, software, electrical, and other changes may be made without departing from the scope of the particular inventions. Various modifications and alterations are possible and expected. Some features of one or more of the inventions may be described with reference to one or more particular embodiments or drawing figures, but such features are not limited to usage in the one or more particular embodiments or figures with reference to which they are described. Thus, the present disclosure is neither a literal description of all embodiments of one or more inventions nor a listing of features of one or more inventions that must be present in all embodiments.

Headings of sections and the title are provided for convenience but are not intended to limit the disclosure in any way or as a basis for interpreting the claims. Devices described as in communication with each other need not be in continuous communication with each other unless expressly specified otherwise. In addition, devices that communicate with each other may communicate directly or indirectly through one or more intermediaries, logical or physical.

A description of an embodiment with several components in communication with one other does not imply that all such components are required. Optional components may be described to illustrate a variety of possible embodiments and to illustrate one or more aspects of the inventions fully. Similarly, although process steps, method steps, algorithms, or the like may be described in sequential order, such processes, methods, and algorithms may generally be configured to work in different orders unless specifically stated to the contrary. Any sequence or order of steps described in this disclosure is not a required sequence or order. The steps of the described processes may be performed in any order practical. Further, some steps may be performed simultaneously. The illustration of a process in a drawing does not exclude variations and modifications, does not imply that the process or any of its steps are necessary to one or more of the invention(s), and does not imply that the illustrated process is preferred. The steps may be described once per embodiment but need not occur only once. Some steps may be omitted in some embodiments or occurrences, or some steps may be executed more than once in a given embodiment or occurrence. When a single device or article is described, more than one device or article may be used in place of a single device or article. Where more than one device or article is described, a single device or article may be used instead of more than one device or article.

The functionality or features of a device may be alternatively embodied by one or more other devices that are not explicitly described as having such functionality or features. Thus, other embodiments of one or more inventions need not include the device itself. Techniques and mechanisms described or referenced herein will sometimes be described in singular form for clarity. However, it should be noted that particular embodiments include multiple iterations of a technique or manifestations of a mechanism unless noted otherwise. Process descriptions or blocks in figures should be understood as representing modules, segments, or portions of code, including one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved.

Various embodiments encompass the subject matter of the following numbered clauses:

1. A computer-implemented method executed using one or more processors of a computer system, the computer-implemented method comprising: accessing digitally stored corpus data and tokenizing the corpus data into sequences of tokens; based on matching the sequences of tokens to a digitally stored part-of-speech (POS) dictionary, generating a plurality of POS sequences; accessing a first treebank data set and storing a plurality of parses from the first treebank data set in a tree data structure in a memory of the one or more computing devices; and for each POS sequence of the plurality of POS sequences: using the tree data structure, identifying one or more candidate parses that match that POS sequence; based on a digitally stored lexical database, selecting a sentence corresponding to one candidate parse of the one or more candidate parses that is most semantically similar to that POS sequence; substituting, in the one candidate parse, words from that POS sequence, to form an updated parse; and digitally storing the updated parse in a second treebank data set.

2. The computer-implemented method of claim 1, further comprising, after accessing the digitally stored corpus data and tokenizing the corpus data into sequences of tokens, storing the sequences of tokens in persistent data storage as processed corpus data.

3. The computer-implemented method of claim 1, wherein the corpus data comprises a large-scale set of digitally stored natural language text organized at least in part in a plurality of sentences.

4. The computer-implemented method of claim 1, further comprising storing and managing during execution of the computer-implemented method, in the main memory of the one or more computing devices, all of the sequences of tokens, possible POS sequences, candidate parses, and the updated parse.

5. The computer-implemented method of claim 1, further comprising training a constituency parser using the second treebank data set.

6. The computer-implemented method of claim 1, wherein the digitally stored corpus data comprises greater than 100,000 sentences.

7. The computer-implemented method of claim 1, wherein the digitally stored corpus data comprises WIKIPEDIA and the digitally stored lexical database comprises WORDNET.

8. One or more non-transitory computer-readable storage media storing one or more sequences of instructions which, when executed using one or more processors of a computer system, cause the one or more processors to execute: accessing digitally stored corpus data and tokenizing the corpus data into sequences of tokens; based on matching the sequences of tokens to a digitally stored part-of-speech (POS) dictionary, generating a plurality of POS sequences; accessing a first treebank data set and storing a plurality of parses from the first treebank data set in a tree data structure in a memory of the one or more computing devices; and for each POS sequence of the plurality of POS sequences: using the tree data structure, identifying one or more candidate parses that match that POS sequence; based on a digitally stored lexical database, selecting a sentence corresponding to one candidate parse of the one or more candidate parses that is most semantically similar to that POS sequence; substituting, in the one candidate parse, words from that POS sequence, to form an updated parse; and digitally storing the updated parse in a second treebank data set.

9. The one or more non-transitory computer-readable storage media of claim 8, further comprising sequences of instructions which, when executed using one or more processors, cause the one or more processors to execute, after accessing the corpus data and tokenizing the corpus data into sequences of tokens, storing the sequences of tokens in persistent data storage as processed corpus data.

10. The one or more non-transitory computer-readable storage media of claim 8, wherein the corpus data comprises a large-scale set of digitally stored natural language text organized at least in part in a plurality of sentences.

11. The one or more non-transitory computer-readable storage media of claim 8, further comprising sequences of instructions which, when executed using one or more processors, cause the one or more processors to execute storing and managing, in the main memory of the one or more computing devices, all of the sequences of tokens, possible POS sequences, candidate parses, and the updated parse.

12. The one or more non-transitory computer-readable storage media of claim 8, further comprising sequences of instructions which, when executed using one or more processors, cause the one or more processors to execute, before tokenizing the corpus data into sequences of tokens, accessing the digitally stored corpus data, deduplicating sentences in the corpus data, removing a plurality of one or more non-parseable sentence fragments from the corpus data, and updating the corpus data after the deduplicating and removing.

13. The one or more non-transitory computer-readable storage media of claim 8, further comprising sequences of instructions which, when executed using one or more processors, cause the one or more processors to execute training a constituency parser using the second treebank data set.

14. The one or more non-transitory computer-readable storage media of claim 8, wherein the digitally stored corpus data comprises WIKIPEDIA and the digitally stored lexical database comprises WORDNET.

15. A computer system, comprising: one or more processors; and one or more non-transitory computer-readable storage media storing one or more sequences of instructions which, when executed using the one or more processors, cause the one or more processors to execute: accessing digitally stored corpus data and tokenizing the corpus data into sequences of tokens; based on matching the sequences of tokens to a digitally stored part-of-speech (POS) dictionary, generating a plurality of POS sequences; accessing a first treebank data set and storing a plurality of parses from the first treebank data set in a tree data structure in a memory of the one or more computing devices; and for each POS sequence of the plurality of POS sequences: using the tree data structure, identifying one or more candidate parses that match that POS sequence; based on a digitally stored lexical database, selecting a sentence corresponding to one candidate parse of the one or more candidate parses that is most semantically similar to that POS sequence; substituting, in the one candidate parse, words from that POS sequence, to form an updated parse; and digitally storing the updated parse in a second treebank data set.

16. The computer system of claim 15, further comprising sequences of instructions which, when executed using one or more processors, cause the one or more processors to execute, after accessing the corpus data and tokenizing the corpus data into sequences of tokens, storing the sequences of tokens in persistent data storage as processed corpus data.

17. The computer system of claim 15, wherein the corpus data comprises a large-scale set of digitally stored natural language text organized at least in part in a plurality of sentences.

18. The computer system of claim 15, further comprising sequences of instructions which, when executed using one or more processors, cause the one or more processors to execute storing and managing, in the main memory of the one or more computing devices, all of the sequences of tokens, possible POS sequences, candidate parses, and the updated parse.

19. The computer system of claim 15, further comprising sequences of instructions which, when executed using one or more processors, cause the one or more processors to execute, before tokenizing the corpus data into sequences of tokens, accessing the digitally stored corpus data, deduplicating sentences in the corpus data, removing a plurality of one or more non-parseable sentence fragments from the corpus data, and updating the corpus data after the deduplicating and removing.

20. The computer system of claim 15, further comprising sequences of instructions which, when executed using one or more processors, cause the one or more processors to execute training a constituency parser using the second treebank data set.

21. The computer system of claim 15, wherein the digitally stored corpus data comprises WIKIPEDIA and the digitally stored lexical database comprises WORDNET.

### 2. Structural & Functional Overview

### 2.1 Distributed Computer System Example

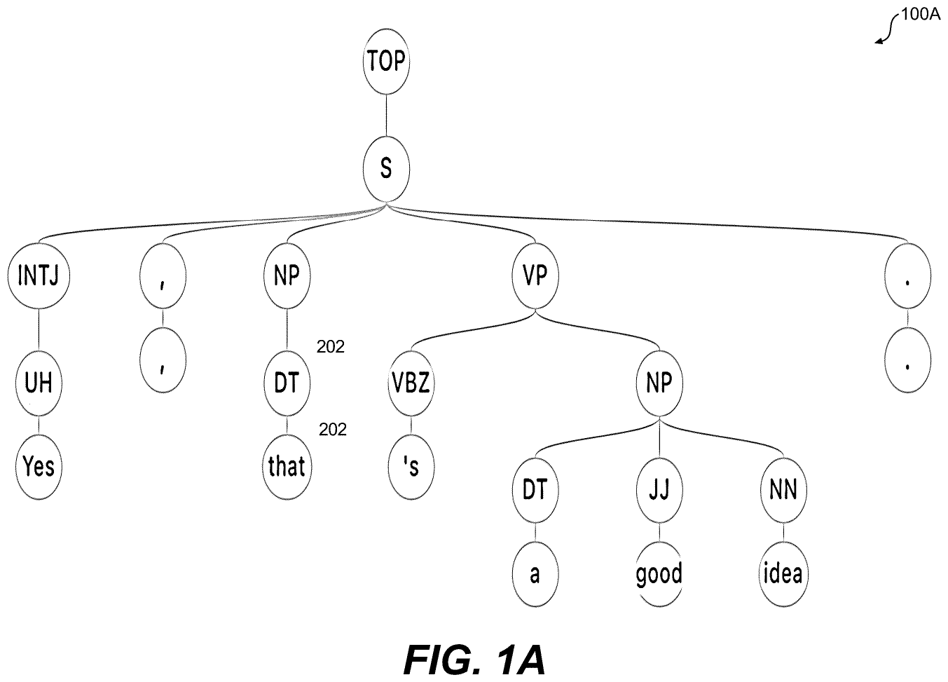

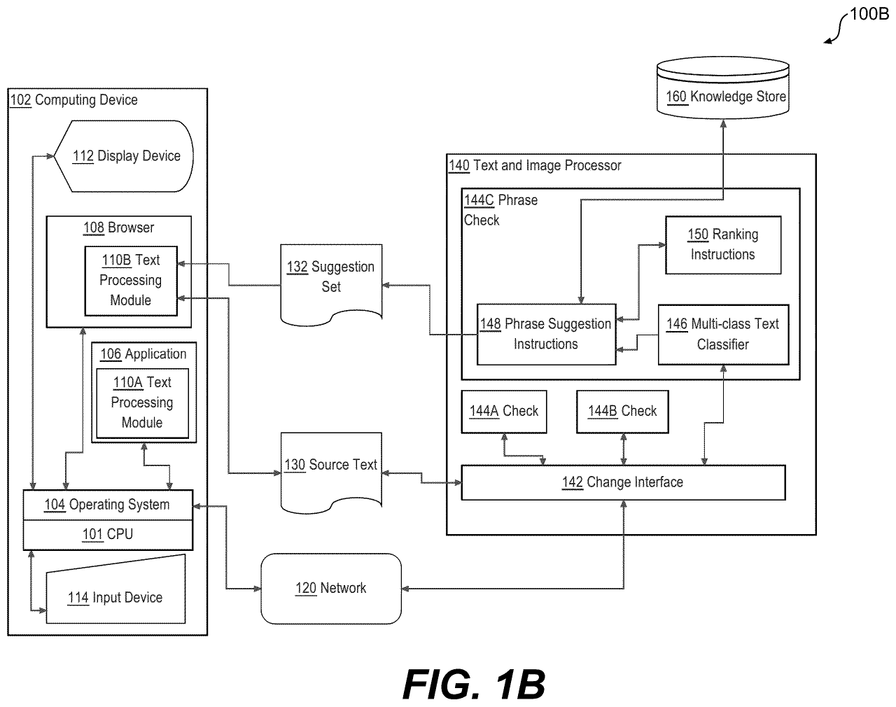

FIG. 1A illustrates a visual tree diagram. As generally depicted, treebank data associates the text of a sentence, clause, or phrase in a natural language with metadata describing the hierarchical structure of sub-sentence syntactic units. For example, a treebank could represent the English sentence “Yes, that's a good idea.” as:

(TOP (S (INT J (UH Yes)) (,,) (NP (DT that )) (VP (VBZ 's) (NP (DT a)
(JJ good) (NN idea))) (..))

The foregoing symbolic representation is termed a parse, and a treebank typically comprises thousands or millions of parses. Elements of FIG. 1A could represent the nodes and edges of a tree in digital storage. The visual representation of FIG. 1A is equivalent to the foregoing treebank in character form. It will be seen that the character form of treebank parses is verbose in comparison to the source text, requires rigid adherence to a specific order and format, and can only be accurate when prepared based on a high degree of accurate knowledge of the relevant natural language. Consequently, creating or finding large-scale parse tree datasets has been challenging.

### 2.2 Distributed Computer System Example

FIG. 1B illustrates a distributed computer system showing the context of use and principal functional elements with which one embodiment could be implemented. In certain embodiments, a computer system 100 may include components implemented at least partially by hardware at one or more computing devices, such as one or more hardware processors executing stored program instructions stored in one or more memories for performing the functions described herein. In other words, all functions described herein are intended to indicate operations performed using programming in a special or general-purpose computer in various embodiments. FIG. 1B illustrates only one of many possible arrangements of components configured to execute the programming described herein. Other arrangements may include fewer or different components, and the division of work between the components may vary depending on the arrangement.

FIG. 1B, and the other drawing figures and all the description and claims in this disclosure, are intended to present, disclose, and claim a technical system and technical methods in which specially programmed computers, using a special-purpose distributed computer system design, execute functions that have not been available before to provide a practical application of computing technology to the problem of machine learning model development, validation, and deployment. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

In the example of FIG. 1B, a computing device 102 is communicatively coupled via a network 120 to a text and image processor 140. In one embodiment, computing device 102 may include a client-type computing device such as a personal computer, laptop, tablet, smartphone, or notebook computer. For purposes of illustrating a clear example, a single computing device 102, network 120, and text and image processor 140 are shown in FIG. 1, but practical embodiments may include thousands to millions of computing devices 102 distributed over a wide geographic area or over the globe, and hundreds to thousands of instances of text and image processor 140 to serve requests and computing requirements of the computing devices.

In certain embodiments, the computing device 102 may include, for example, a central processing unit (CPU) 101 coupled via a bus to a display device 112 and an input device 114. In some embodiments display device 112 and input device 114 are integrated, for example, using a touch-sensitive screen to implement a soft keyboard. CPU 101 hosts operating system 104, which may include a kernel, primitive services, a networking stack, and similar foundation elements implemented in software, firmware, or a combination. Operating system 104 supervises and manages one or more other programs. For the purpose of illustrating a clear example, FIG. 1 shows the operating system 104 coupled to an application 106 and a browser 108, but other embodiments may have more or fewer apps or applications hosted on computing device 102.

In one embodiment, at runtime, one or more of application 106 and browser 108 may load or be installed with a text processing module 110A, 110B, which comprises executable instructions that are compatible with text and image processor 140 and may implement application-specific communication protocols to rapidly communicate text-related commands and data between the module and the text processor. Text processing modules 110A and 110B may be implemented as runtime libraries, browser plug-ins, browser extensions, or other means of adding external functionality to otherwise unrelated third-party applications or software. The precise means of implementing a text processing module 110A, 110B or to obtain input text is not critical provided that, if text processing module 110A, 110B is implemented as an extension, then said extension is compatible with and can be functionally integrated with a host application 106 or browser 108. As explained further herein with more specificity, text processing modules 110A and 110B may also be implemented as a standalone application instead of an extension.

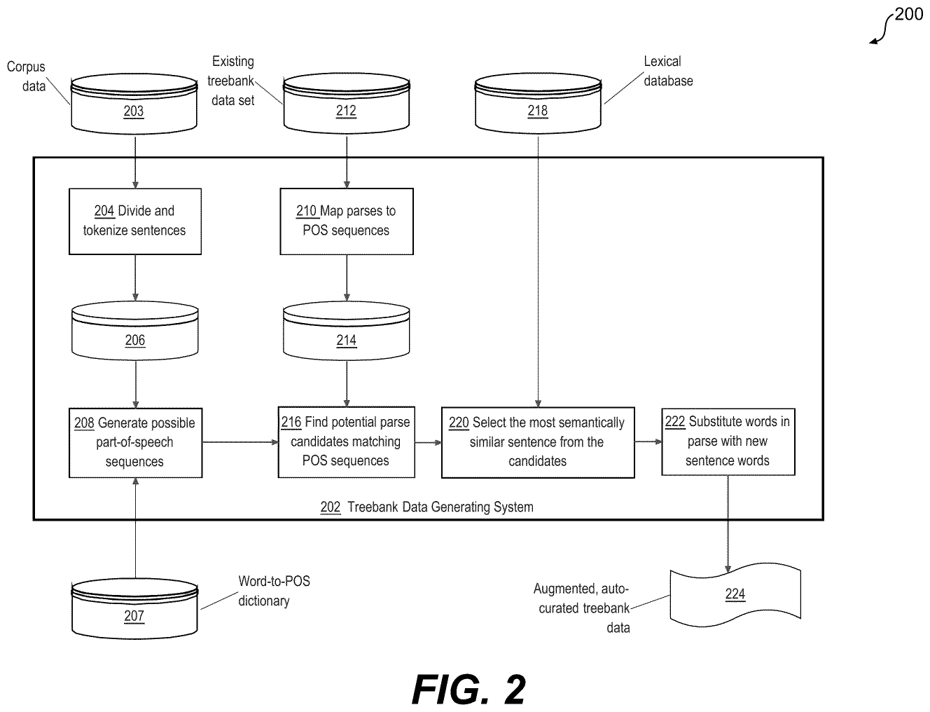

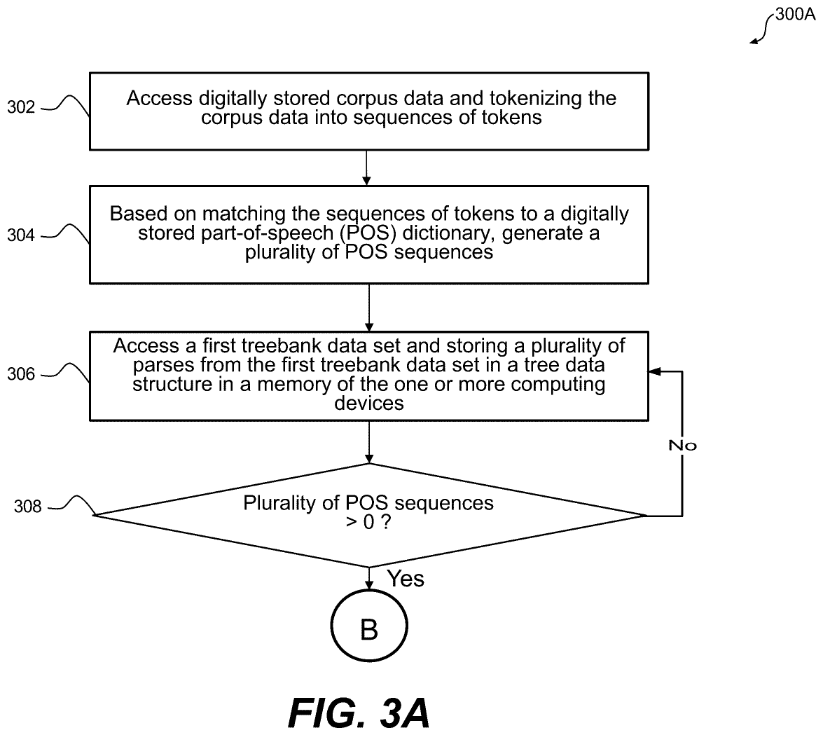

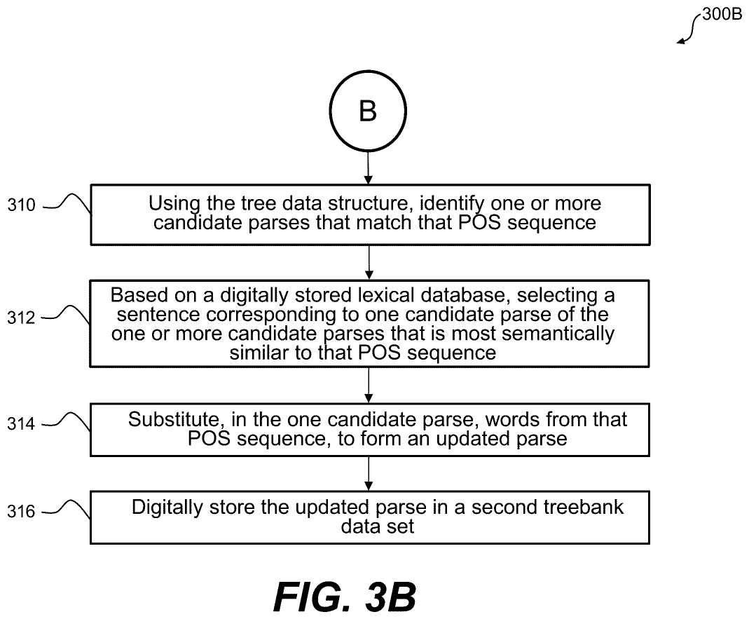

In some embodiments, a text processing module 110A may be installed as a stand-alone application that communicates programmatically with either or both operating system 104 and application 106. For example, in one implementation, text processing module 110A executes independently of application 106 and programmatically calls services or APIs of operating system 104 to obtain the text that has been entered in or is being entered in input fields that the application manages. Accessibility services or accessibility APIs of the operating system 104 may be called for this purpose. For example, an embodiment may call an accessibility API that normally obtains input text from the application 106 and outputs speech to audibly speak the text to the user but use the text obtained by the accessibility service in the processes that are described in FIG. 2, FIG. 3, and other sections herein. Examples of accessibility APIs that may be used for these purposes include UI Automation, IAccessible2, and OS X Accessibility.

In one embodiment, text processing module 110A, 110B may execute programmed instructions formatted to cause subscribing to one or more events provided by APIs, including one or more events provided by the aforementioned accessibility APIs. In various embodiments, the programmed instructions are formatted to cause subscribing to one or more APIs provided by an operating system 104, such as a WINDOWS or a MAC OS operating system. Such APIs may be referred to as “low-level” APIs. A text processing module can be programmed to programmatically subscribe to layout change, scroll, or other events. Such events may indicate a change in focused elements or a likelihood of different text being displayed on display device 112.

In some embodiments, events required for detecting new text displayed on display device 112 may not be received by text processing module 110A, 110B. In such embodiments, global event hooks (such as CGEventTap) may be programmatically implemented to observe mouse or trackpad input, and content updates may be triggered based on those observations. For example, text processing module 110A, 110B may be programmed to observe scroll events, mouse movement events, mouse button pressed events, arrow key pressed events, or other events and to schedule light-weight updates for such events. In certain embodiments, subsequent scroll events may be ignored while the update is being processed, and then it may be subsequently processed. In one embodiment, in the WINDOWS context, the equivalent functionality of CGEventTap may be accomplished using SendInput and SetWindowsHookEx.

In some embodiments, each text processing module 110A, 110B is linked, loaded with, or otherwise programmatically coupled to or with one or more of application 106 and browser 108 and, in this configuration, is capable of calling API calls, internal methods or functions, or other programmatic facilities of the application or browser. These calls or other invocations of methods or functions enable each text processing module 110A, 110B to detect text that is entered in input fields, windows, or panels of application 106 or browser 108, instruct the application or browser to delete a character, word, sentence, or another unit of text, and instruct the application or browser to insert a character, word, sentence, or another unit of text.

Each of the text processing modules 110A, 110B is programmed to interoperate with a host application 106 or browser 108 to detect the entry of text in a text entry function of the application or browser and/or changes in the entered text, to transmit changes in the text to text and image processor 140 for server-side checking and processing, to receive responsive data and commands from the text processor, and to execute presentation functions in cooperation with the host application or browser.

As one functional example, assume that browser 108 renders an HTML document with a text entry panel where a user can enter free-form text describing a product or service. The text processing module 110B is programmed to detect user selection of the text entry panel, the text entry, or changes in the text within the panel and to transmit all such text changes to text and image processor 140. In certain embodiments, each text processing module 110A, 110B is programmed to buffer or accumulate text changes locally over a programmable period, for example, five seconds, and to transmit the accumulated changes over that period as a batch to text and image processor 140. While not required, buffering or accumulation in this manner may improve performance by reducing network messaging roundtrips and reducing the likelihood that text changes could be lost due to packet drops in the networking infrastructure.

A commercial example of text processing modules 110A, 110B is the GRAMMARLY extension, commercially available from Grammarly, Inc.

Network 120 broadly represents one or more local area networks, wide area networks, campus networks, or internetworks in any combination, using links such as terrestrial or satellite, wired, or wireless network links.

In certain embodiments, the text and image processor 140 may include one or more server computers, workstations, computing clusters, and/or virtual machine processor instances, with or without network-attached storage or directly attached storage, located in any of enterprise premises, private datacenter, public data center and/or cloud computing center. The text and image processor 140 broadly represents a programmed server computer with processing throughput and storage capacity sufficient to communicate concurrently with thousands to millions of computing devices 102 associated with different users or accounts. For purposes of illustrating a clear example and focusing on innovations that are relevant to the appended claims, FIG. 1 omits basic hardware elements of text and image processor 140 such as a CPU, bus, I/O devices, main memory, and the like, illustrating instead an example software architecture for functional elements that execute on the hardware elements. Text and image processor 140 also may include foundational software elements not shown in FIG. 1B, such as an operating system consisting of a kernel and primitive services, system services, a networking stack, an HTTP server, other presentation software, and other application software. Thus, text and image processor 140 may execute on the first computer, and text processing modules 110A and 110B may execute on a second computer.

In certain embodiments, the text and image processor 140 may include a change interface 142 coupled indirectly to network 120. Change interface 142 is programmed to receive the text changes that text processing modules 110A and 110B transmit to text and image processor 140 and to distribute the text changes to a plurality of different checks 144A, 144B, 144C. To illustrate a clear example, source text 130 of FIG. 1 represents one or more text changes that text processing module 110B transmits to change interface 142. In certain embodiments, change interface 142 is programmed to distribute every text change from a text processing module 110A, 110B to all of the checks 144A, 144B, 144C, which execute in parallel and/or in independent threads.

Thus, in one embodiment, the text and image processor 140 may be programmed to access digitally stored corpus data and tokenizing the corpus data into sequences of tokens; based on matching the sequences of tokens to a digitally stored part-of-speech (POS) dictionary, generating a plurality of POS sequences; accessing a first treebank data set and storing a plurality of parses from the first treebank data set in a tree data structure in a memory of the one or more computing devices; and for each POS sequence of the plurality of POS sequences: using the tree data structure, identifying one or more candidate parses that match that POS sequence; based on a digitally stored lexical database, selecting a sentence corresponding to one candidate parse of the one or more candidate parses that is most semantically similar to that POS sequence; substituting, in the one candidate parse, words from that POS sequence, to form an updated parse; and digitally storing the updated parse in a second treebank data set.

Each of the checks 144A, 144B, 144C is programmed to execute a different form of checking or processing of a text change that has arrived. Example functions that checks 144A, 144B could be implemented include grammar checking, tone detection, spell checking, and translation. In certain embodiments, check 144C is programmed as a phrase check; therefore, it is also denoted “phrase check 144” in this description. In certain embodiments, phrase check 144 may include a multi-class text classifier coupled to phrase suggestion instructions 148, coupled to ranking instructions 150; however, other machine learning models can be used. For example, an embodiment may use several individual text classifiers ensembled together, or targeted rules may be programmed to find relevant words and then coupled to a classifier to approve or reject whether the instance of a word is correct, thus using a coarse rule followed by ML-based filtering.

Furthermore, phrase check 144C is coupled to, or can access, a knowledge store 160, which may be integrated with text and image processor 140 or implemented as separate storage. In certain embodiments, knowledge store 160 may include a database, flat file system, object store, or another digital data repository that stores a large number of textual phrase suggestions in association with category values or tags that specify a category or type of communication, text, or document in which the suggestions could be substituted. Thus, phrase check 144 and/or text and image processor 140 may be programmed for evaluating each particular source text unit among the plurality of source text units using a trained multi-class text classifier machine learning model and receiving a classification output from the multi-class text classifier that classifies each particular source text unit as a particular class of phrase among a plurality of possible classes of phrases. In certain embodiments, phrase suggestion instructions 148 are programmed, in part, to output a suggestion set 132 to transmit to text processing module 110B.

### 2.3 Data Processing Example

FIG. 2 illustrates a programmed data flow and distributed computer system showing the context of use and principal functional elements with which one embodiment could be implemented. In an embodiment, the computer system of FIG. 2 comprises components implemented at least partially by hardware at one or more computing devices, such as one or more hardware processors executing stored program instructions stored in one or more memories for performing the functions that are described herein. In other words, all functions described herein are intended to indicate operations performed using programming in a special or general-purpose computer in various embodiments. The term “computing device,” as used herein, can include a desktop computer, laptop computer, workstation, server computer, and/or a virtual compute instance and virtual storage instance of a cloud computing system, public data center, or private data center, or a combination of one or more of the foregoing. FIG. 2 illustrates only one of many possible arrangements of components configured to execute the programming described herein. Other arrangements may include fewer or different components, and the division of work between the components may vary depending on the arrangement.

FIG. 2, and the other drawing figures and all of the description and claims in this disclosure, are intended to present, disclose and claim a technical system and technical methods in which specially programmed computers, using a special-purpose distributed computer system design, execute functions that have not been available before to provide a practical application of computing technology to the problem of automatically generating curated treebank data. In this manner, the disclosure presents a technical solution to a technical problem, and any interpretation of the disclosure or claims to cover any judicial exception to patent eligibility, such as an abstract idea, mental process, method of organizing human activity, or mathematical algorithm, has no support in this disclosure and is erroneous.

Furthermore, FIG. 2 and each other data flow or process diagram herein is intended to illustrate the functional level at which skilled persons, in the art to which this disclosure pertains, communicate with one another to describe and implement algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In an embodiment, a treebank data generating system 202 comprises sets of stored program instructions programmed to implement the functions described in the following sections in cooperation with online digital data storage. In one embodiment, system 202 can be implemented using one or more programs or libraries executed or hosted using one or more virtual compute instances and virtual storage instances of a public, commercial cloud computing environment or private data center. In another embodiment, system 202 can comprise a server computer with application programs executed in an on-premises environment with access to networked or network-attached storage.

System 202 receives or reads the data in four datasets as input in an embodiment. Corpus data 203 comprises a large set of digitally stored text. Typically the corpus data 203 comprises a large, structured, or unstructured set of digitally stored natural language text organized as sentences; corpus data having an arbitrary number of sentences can be processed, and embodiments can be capable of processing from 100,000 to 10 million sentences or more. An example is the full text of the WIKIPEDIA open encyclopedia system. While the use of Wikipedia data can be convenient, it is not required, and other large-scale text sets in a target language can be used.

An existing treebank data set 212 comprises any treebank data that has been previously obtained from a natural language processing system, curated, or annotated. A word-to-part-of-speech (POS) dictionary 207 provides a reference point for mapping input text to parts of speech. A lexical semantic ontology and/or database 218 enables the definition of algorithms to select sentences based on semantic similarity; an example is WORDNET, which is publicly available from Princeton University.

In an embodiment, system 202 is programmed to operate as follows. System 202 is programmed to read digitally stored corpus data and perform sentence splitting and tokenization of the corpus data, which can involve dividing the corpus data into sequences of tokens. In this context, the term “dividing” is intended as equivalent to “tokenizing” and can, in some cases, also concatenate words into single tokens. For example, “New York” can be treated as a single token rather than two tokens corresponding to the words “New” and “York, depending on the tokenization algorithm. At block 204, system 202 is programmed to access and read the corpus data 203 and divide the corpus data into sentences or tokens, stored as processed corpus data 206. The processed corpus data 206 can be stored in a flat file system, one or more relational database tables, an object store, or other digital data storage. The specific method of tokenization is not critical, and block 204 can be programmed using known tokenization methods such as the split( ) function of Python, the text_to_word_sequence( ) function of Keras, word_tokenize( ) in NLTK, or others.

System 202 is also programmed, based on matching the sequences of tokens to a digitally stored part-of-speech (POS) dictionary, for generating a plurality of POS sequences. At block 208, system 202 is programmed to generate a plurality of possible part-of-speech sequences from the processed corpus data 206, based on the word-to-POS dictionary 207. A part-of-speech sequence can comprise a copy of a sequence of tokens received from block 204 and tagged or labeled with POS identifiers based on lookups or matches with the word-to-POS dictionary 207. Additionally, or alternatively, an embodiment can be programmed with algorithms to predict or estimate the POS of unknown tokens using programmed rules, heuristics, or a trained machine learning model.

Thereafter, or in parallel with blocks 204, 208, system 202 is programmed for accessing a first treebank data set and storing a plurality of parses from the first treebank data set in a tree data structure in the main memory of one or more computing devices. In an embodiment, at block 210, system 202 is programmed to read or reference the existing treebank data set 212 and to map the parses of the existing treebank data to POS sequences, which are then stored in a POS tree data structure 214. The tree data structure 214 typically is maintained in the main memory of the virtual compute instance or server as system 202 executes, but in some embodiments, the data structure can be paged out to disk or stored in a persistent digital repository. While a tree is mentioned here to illustrate a clear example, other embodiments can use other forms of k-ary search trees or keyed search trees. The specific structure is not critical, provided that system 202 can query a digitally stored representation of the existing treebank data in a format that facilitates fast, machine-driven lookups of parses that correspond to POS sequences.

System 202 is also programmed to execute, for each POS sequence among the plurality of POS sequences: using the tree data structure, identifying one or more candidate parses that match that POS sequence; based on a digitally stored lexical database, selecting a sentence corresponding to one candidate parse among the one or more candidate parses that is most semantically similar to that POS sequence; substituting, in the one candidate parse, words from that POS sequence, to form an updated parse; digitally storing the updated parse in a second treebank data set. In an embodiment, at block 216, the POS tree data structure 214 is used to identify or find potential parse candidates among the existing treebank data set 212 that match the POS sequences generated at block 208. Thus, the POS sequences of block 208 form input to block 216, which finds potential candidates based on read, lookup, or search operations against the POS tree data structure 214. The result of block 216 will be a set of potential parse candidates, which can be transiently stored in the main memory during subsequent operations.

At block 220, system 200 is programmed to select the candidate parse most semantically similar to the input sentence from among all the candidates. Instructions executing at block 220 can call, read or reference the lexical semantic ontology and/or database 218 to conduct the selection. For example, for a given POS sequence of a source sentence, instructions executing at block 220 leverage the lexical semantic ontology and/or database is semantically similar to the token sequence of the source sentence. In one embodiment, block 220 can query the lexical semantic ontology and/or database 218 successively using API calls to compute or quantify the extent to which a particular token sequence of a parse candidate is semantically similar to the token sequence of the source sentence. Successive calls evaluate different parse candidates, and response values from the lexical-semantic ontology and/or database 218 can be ranked to indicate the most semantically similar sentence. The determination of similarity at block 220 can use stored program instructions that implement any known similarity algorithm or distance algorithm, and the particular mechanism for determining similarity is not critical.

Thus, block 220 can be programmed to conduct the best match of a particular POS sequence to a particular parse in the tree data structure 214 from among the candidate parses identified at block 216. Additionally, or alternatively, the process can be programmed to filter out results below a specified similarity threshold, and a best-match approach is not required.

At block 222, system 202 is programmed to substitute words in the candidate parse, which was selected as the best candidate, with words from the new sentence obtained from the corpus. The resulting parse is written to persistent storage to form augmented, auto-curated treebank data 224. The processing of blocks 204, 208, 210, 216, 220, 222 iterates for all sentences and sequences of tokens derived from the corpus data 203 until the entire corpus is processed or until the number of parses in the auto-curated treebank data 224 has reached a number or volume to train a constituency parser effectively. The target number of parses can be specified in configuration data, which the system 202 consults or tests as execution rounds continue. The system can be programmed to end processing when the treebank data 224 has a number of parses that equals or exceeds the target number stored in the configuration data.

The existing treebank data set 212 can be termed a first treebank data set, and the treebank data 224 can be termed a second treebank data set. In some embodiments, a constituency parser is trained using only the second treebank data set or a combination of the first and the second treebank data set. The specific configuration of a constituency parser and the configuration of files or programs to execute training are not critical, and any constituency parser can be used. For example, a parser can implement Cocke-Kasami-Younger constituency parsing based on a probabilistic context-free grammar. The parser can use an encoder-decoder design in which an encoder reads an input sentence and summarizes it into a vector or set of vectors, and then a decoder uses the vector summaries to create and store a labeled parse tree incrementally. Encoders in such parsers can use recurrent neural networks (RNNs), including Long Short-Term Memory (LSTM) networks. Any such neural parser can receive the treebank data 224 for training purposes. Training with the treebank data 224 can be the sole form of training the model or can be combined with pre-training.

### 2.5 Method for Providing Treebank Data for a Constituency Parser and Executing the Training Phase of the Constituency Parser

FIG. 3A and FIG. 3B illustrates a flow diagram of an example method 300A, 300B for providing treebank data for a constituency parser and executing the training phase of the constituency parser in accordance with the disclosed embodiments. FIG. 3A and FIG. 3B and each other flow diagram herein are intended as an illustration of the functional level at which skilled persons, in the art to which this disclosure pertains, communicate with one another to describe and implement a computer-implemented method, as described further herein and/or algorithms using programming. The flow diagrams are not intended to illustrate every instruction, method object, or sub-step that would be needed to program every aspect of a working program but are provided at the same functional level of illustration that is normally used at the high level of skill in this art to communicate the basis of developing working programs.

In one embodiment, a method 300A, 300B may be performed utilizing one or more processing devices (e.g., text and image processor 140 as discussed above with respect to FIG. 1) that may include hardware (e.g., a general-purpose processor, a graphic processing unit (GPU), an application-specific integrated circuit (ASIC), a system-on-chip (SoC), a microcontroller, a field-programmable gate array (FPGA), a central processing unit (CPU), an application processor (AP), a visual processing unit (VPU), a neural processing unit (NPU), a neural decision processor (NDP), a deep learning processor (DLP), a tensor processing unit (TPU), a neuromorphic processing unit (NPU), or any other artificial intelligence (AI) accelerator device(s) that may be suitable for processing natural language data and making one or more predictions or decisions based thereon), firmware (e.g., microcode), or some combination thereof.

The method 300A, 300B may begin at block 302 with the one or more processors (e.g., text and image processor 140) accessing digitally stored corpus data and tokenizing the corpus data into sequences of tokens. In certain embodiments, based on matching the sequences of tokens to a digitally stored part-of-speech (POS) dictionary, the method 300A, 300B may continue at block 304 with the one or more processors (e.g., text and image processor 140) generating a plurality of POS sequences. The method 300A, 300B may continue at block 306 with the one or more processors (e.g., text and image processor 140) accessing a first treebank data set and storing a plurality of parses from the first treebank data set in a tree data structure in a memory of the one or more computing devices.

The method 300A, 300B may continue at decision 308 with the one or more processors (e.g., text and image processor 140) executing an iterative process for each POS sequence of the plurality of POS sequences. For example, for each POS sequence of the plurality of POS sequences, the method 300A, 300B may continue at block 310 with the one or more processors (e.g., text and image processor 140) using the tree data structure to identify one or more candidate parses that match that POS sequence. The method 300A, 300B may then continue at block 312 with the one or more processors (e.g., text and image processor 140), based on a digitally stored lexical database, selecting a sentence corresponding to one candidate parse of the one or more candidate parses that is most semantically similar to that POS sequence. The method 300A, 300B may continue at block 314 with the one or more processors (e.g., text and image processor 140) substituting, in the one candidate parse, words from that POS sequence, to form an updated parse. The method 300A, 300B may then conclude at block 316 with the one or more processors (e.g., text and image processor 140) digitally storing the updated parse in a second treebank data set.

### 2.6 Benefits and Improvements

Based on the foregoing, it will be apparent that supplying or providing the treebank data 224 to a constituency parser and executing the training phase of a constituency parser is a practical application of the technology described in this disclosure. In particular, the disclosure is not limited to accessing and transforming digitally stored text of natural language from one form to another, but the programmed steps and functions that have been previously described offer a useful and practical result by outputting treebank data 224 that is capable of training of a constituency parser to improve the accuracy and performance of the parser.

With the foregoing process, a limited number of parses in the existing treebank data form a reference point to bootstrap the synthetic creation of many new treebank parses based on a large corpus of data. For each new, unparsed sentence drawn from the corpus, a dictionary maps tokens to POS tags, existing parsed candidate sentences composed of words or tokens with the same sequence of POS tags are extracted, and a lexical semantic ontology/database is leveraged to select the most semantically similar candidate among multiple candidates efficiently. Mapping the existing treebank data set to an in-memory tree structure provides an innovative technical solution, not possible using mental steps or other non-machine efforts, to enable the rapid, efficient identification of existing parse candidates that could match an input POS sequence while processing a large source corpus. In this manner, using a technical element that only machines can process—the tree structure or the alternatives mentioned in other sections of the disclosure—allows the computer to use a smaller set of existing treebank data to efficiently drive the synthesis of a far more extensive set of automatically curated treebank data with a high degree of accuracy. The approach, therefore, provides effective technical means to solve the problems described in the Background.

Embodiments have numerous benefits over prior approaches. The first benefit is improved performance. In one laboratory configuration, the inventors executed the process of FIG. 2 on over 50,000 unique parsed sentences. The inventors separated 5,000 sentences to form a development set, thus dividing the dataset roughly 90%/10% in training data compared to evaluation data. The inventors then trained two models; a first model was trained using all existing training data (the first treebank data set), and a second model was trained with the additional 48,000 generated parses partitioned to add to the train set. Testing indicated an improvement of at least 6% to 12% in parse precision and recall (as well as POS tagging) accuracy over prior approaches.

The embodiments described herein are known to be extensible to languages other than English. Fundamentally, embodiments use lexical information and semantic ontologies to help map novel sentences to existing parses. This approach can bootstrap additional treebank data to build parsers that are robust to new domains, including any additional languages that have a POS dictionary and lexical-semantic ontology available. Embodiments also can assist in the correction of errors produced by other ML approaches.

### 3. Implementation Example—Hardware Overview

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body-mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

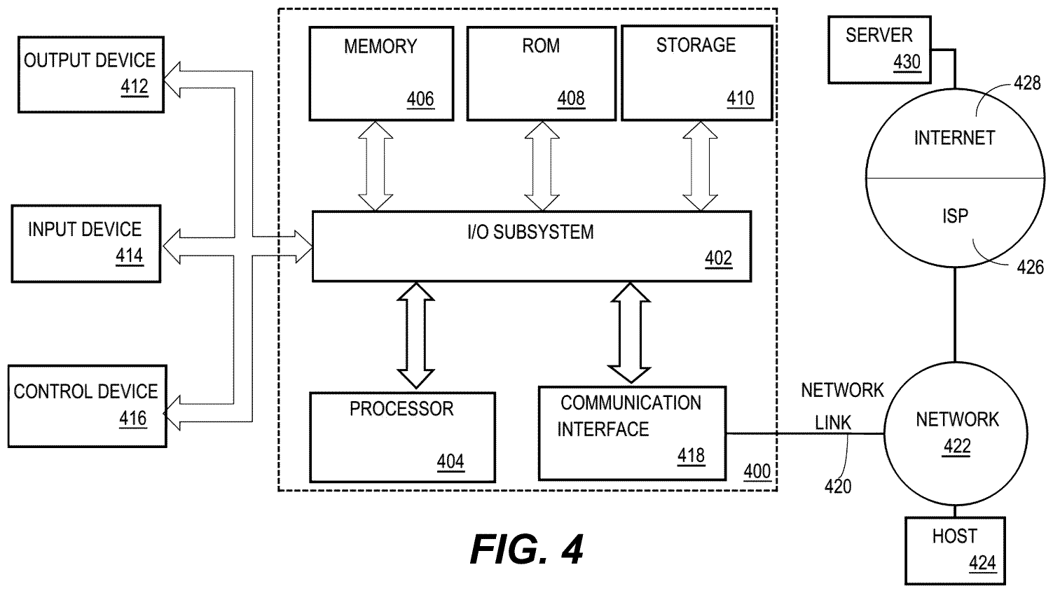

FIG. 4 is a block diagram that illustrates an example computer system with which an embodiment may be implemented. In the example of FIG. 4, a computer system 400 and instructions for implementing the disclosed technologies in hardware, software, or a combination of hardware and software, are represented schematically, for example, as boxes and circles, at the same level of detail that is commonly used by persons of ordinary skill in the art to which this disclosure pertains for communicating about computer architecture and computer systems implementations.

Computer system 400 includes an input/output (I/O) subsystem 402, which may include a bus and/or other communication mechanism(s) for communicating information and/or instructions between the components of the computer system 400 over electronic signal paths. The I/O subsystem 402 may include an I/O controller, a memory controller, and at least one I/O port. The electronic signal paths are represented schematically in the drawings, for example, as lines, unidirectional arrows, or bidirectional arrows.

At least one hardware processor 404 is coupled to I/O subsystem 402 for processing information and instructions. Hardware processor 404 may include, for example, a general-purpose microprocessor or microcontroller and/or a special-purpose microprocessor such as an embedded system or a graphics processing unit (GPU), or a digital signal processor or ARM processor. Processor 404 may comprise an integrated arithmetic logic unit (ALU) or may be coupled to a separate ALU.

Computer system 400 includes one or more units of memory 406, such as a main memory, which is coupled to I/O subsystem 402 for electronically digitally storing data and instructions to be executed by processor 404. Memory 406 may include volatile memory such as various forms of random-access memory (RAM) or other dynamic storage device. Memory 406 also may be used for storing temporary variables or other intermediate information during the execution of instructions to be executed by processor 404. Such instructions, when stored in non-transitory computer-readable storage media accessible to processor 404, can render computer system 400 into a special-purpose machine that is customized to perform the operations specified in the instructions.

Computer system 400 further includes non-volatile memory such as read-only memory (ROM) 308 or other static storage devices coupled to I/O subsystem 402 for storing information and instructions for processor 404. The ROM 408 may include various forms of programmable ROM (PROM), such as erasable PROM (EPROM) or electrically erasable PROM (EEPROM). A unit of persistent storage 410 may include various forms of non-volatile RAM (NVRAM), such as FLASH memory, solid-state storage, magnetic disk, or optical disks such as CD-ROM or DVD-ROM and may be coupled to I/O subsystem 402 for storing information and instructions. Storage 410 is an example of a non-transitory computer-readable medium that may be used to store instructions and data, which, when executed by the processor 404, causes performing computer-implemented methods to execute the techniques herein.

The instructions in memory 406, ROM 408, or storage 410 may comprise one or more sets of instructions that are organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server, or web client. The instructions may be organized as a presentation layer, application layer, and data storage layer, such as a relational database system using a structured query language (SQL) or no SQL, an object store, a graph database, a flat file system, or other data storage.

Computer system 400 may be coupled via I/O subsystem 402 to at least one output device 412. In one embodiment, output device 412 is a digital computer display. Examples of a display that may be used in various embodiments include a touchscreen display or a light-emitting diode (LED) display or a liquid crystal display (LCD), or an e-paper display. Computer system 400 may include other type(s) of output devices 412, alternatively or in addition to a display device. Examples of other output devices 412 include printers, ticket printers, plotters, projectors, sound cards or video cards, speakers, buzzers or piezoelectric devices or other audible devices, lamps or LED or LCD indicators, haptic devices, actuators or servos.

At least one input device 414 is coupled to I/O subsystem 402 for communicating signals, data, command selections, or gestures to processor 404. Examples of input devices 414 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 416, which may perform cursor control or other automated control functions such as navigation in a graphical interface on a display screen, alternatively or in addition to input functions. Control device 416 may be a touchpad, a mouse, a trackball, or cursor direction keys for communicating direction information and command selections to processor 404 and for controlling cursor movement on an output device 412 such as a display. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism, or other type of control device. An input device 414 may include a combination of multiple different input devices, such as a video camera and a depth sensor.

In another embodiment, computer system 400 may comprise an Internet of Things (IoT) device in which one or more of the output device 412, input device 414, and control device 416 are omitted. Or, in such an embodiment, the input device 414 may comprise one or more cameras, motion detectors, thermometers, microphones, seismic detectors, other sensors or detectors, measurement devices or encoders, and the output device 412 may comprise a special-purpose display such as a single-line LED or LCD display, one or more indicators, a display panel, a meter, a valve, a solenoid, an actuator or a servo.

When computer system 400 is a mobile computing device, input device 414 may comprise a global positioning system (GPS) receiver coupled to a GPS module that is capable of triangulating to a plurality of GPS satellites, determining and generating geo-location or position data such as latitude-longitude values for a geophysical location of the computer system 400. Output device 412 may include hardware, software, firmware, and interfaces for generating position reporting packets, notifications, pulse or heartbeat signals, or other recurring data transmissions that specify a position of the computer system 400, alone or in combination with other application-specific data, directed toward host computer 424 or server computer 430.

Computer system 400 may implement the techniques described herein using customized hard-wired logic, at least one ASIC or FPGA, firmware, and/or program instructions or logic which, when loaded and used or executed in combination with the computer system, causes or programs the computer system to operate as a special-purpose machine. According to one embodiment, the techniques herein are performed by computer system 400 in response to processor 404 executing at least one sequence of at least one instruction contained in main memory 406. Such instructions may be read into main memory 406 from another storage medium, such as storage 410. Execution of the sequences of instructions contained in main memory 406 causes processor 404 to perform the process steps described herein. In alternative embodiments, hard-wired circuitry may be used in place of or in combination with software instructions.

The term “storage media,” as used herein, refers to any non-transitory media that store data and/or instructions that cause a machine to operate in a specific fashion. Such storage media may comprise non-volatile media and/or volatile media. Non-volatile media includes, for example, optical or magnetic disks, such as storage 410. Volatile media includes dynamic memory, such as memory 406. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire, and fiber optics, including the wires that comprise a bus of I/O subsystem 402. Transmission media can also be acoustic or light waves, such as those generated during radio-wave and infrared data communications.

Various forms of media may be involved in carrying at least one sequence of at least one instruction to processor 404 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 400 can receive the data on the communication link and convert the data to a format that can be read by computer system 400. For instance, a receiver such as a radio frequency antenna or an infrared detector can receive the data carried in a wireless or optical signal, and appropriate circuitry can provide the data to I/O subsystem 402, such as placing the data on a bus. I/O subsystem 402 carries the data to memory 406, from which processor 404 retrieves and executes the instructions. The instructions received by memory 406 may optionally be stored on storage 410 either before or after execution by processor 404.

Computer system 400 also includes a communication interface 418 coupled to I/O subsystem 402. Communication interface 418 provides a two-way data communication coupling to network link(s) 420 that are directly or indirectly connected to at least one communication network, such as network 422 or a public or private cloud on the Internet. For example, communication interface 418 may be an Ethernet networking interface, integrated-services digital network (ISDN) card, cable modem, satellite modem, or a modem to provide a data communication connection to a corresponding type of communications line, for example, an Ethernet cable or a metal cable of any kind or a fiber-optic line or a telephone line. Network 422 broadly represents a local area network (LAN), wide-area network (WAN), campus network, internetwork, or any combination thereof. Communication interface 418 may comprise a LAN card to provide a data communication connection to a compatible LAN, a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 418 sends and receives electrical, electromagnetic, or optical signals over signal paths that carry digital data streams representing various types of information.

Network link 420 typically provides electrical, electromagnetic, or optical data communication directly or through at least one network to other data devices, using, for example, satellite, cellular, Wi-Fi, or BLUETOOTH technology. For example, network link 420 may provide a connection through network 422 to a host computer 424.

Furthermore, network link 420 may provide a connection through network 422 or to other computing devices via internetworking devices and/or computers that are operated by an Internet Service Provider (ISP) 326. ISP 426 provides data communication services through a worldwide packet data communication network represented as Internet 428. A server computer 430 may be coupled to Internet 428. Server computer 430 broadly represents any computer, data center, virtual machine, or virtual computing instance with or without a hypervisor or computer executing a containerized program system such as DOCKER or KUBERNETES. Server computer 430 may represent an electronic digital service that is implemented using more than one computer or instance and that is accessed and used by transmitting web services requests, uniform resource locator (URL) strings with parameters in HTTP payloads, API calls, app services calls, or other service calls. Computer system 400 and server computer 430 may form elements of a distributed computing system that includes other computers, a processing cluster, a server farm, or other organizations of computers that cooperate to perform tasks or execute applications or services. Server computer 430 may comprise one or more sets of instructions that are organized as modules, methods, objects, functions, routines, or calls. The instructions may be organized as one or more computer programs, operating system services, or application programs, including mobile apps. The instructions may comprise an operating system and/or system software; one or more libraries to support multimedia, programming, or other functions; data protocol instructions or stacks to implement TCP/IP, HTTP, or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server computer 430 may comprise a web application server that hosts a presentation layer, application layer, and data storage layer, such as a relational database system using a structured query language (SQL) or no SQL, an object store, a graph database, a flat file system or other data storage.

Computer system 400 can send messages and receive data and instructions, including program code, through the network(s), network link 420, and communication interface 418. In the Internet example, a server computer 430 might transmit a requested code for an application program through Internet 428, ISP 426, local network 422, and communication interface 418. The received code may be executed by processor 404 as it is received and/or stored in storage 410 or other non-volatile storage for later execution.

The execution of instructions, as described in this section, may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 404. While each processor 404 or core of the processor executes a single task at a time, computer system 400 may be programmed to implement multitasking to allow each processor to switch between tasks that are being executed without having to wait for each task to finish. In an embodiment, switches may be performed when tasks perform input/output operations when a task indicates that it can be switched or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application in the specific form in which such claims issue, including any subsequent correction.

What is claimed is:

1. A computer-implemented method executed using one or more processors of a computer system, the computer-implemented method comprising:
accessing digitally stored corpus data and tokenizing the corpus data into sequences of tokens;
based on matching the sequences of tokens to a digitally stored part-of-speech (POS) dictionary, generating a plurality of POS sequences;
accessing a first treebank data set and storing a plurality of parses from the first treebank data set in a tree data structure in a memory of the computer system; and
for each POS sequence of the plurality of POS sequences:
using the tree data structure, identifying one or more candidate parses that match that POS sequence;
based on a digitally stored lexical database, selecting a sentence corresponding to one candidate parse of the one or more candidate parses that is most semantically similar to that POS sequence;
substituting, in the one candidate parse, words from that POS sequence, to form an updated parse; and
digitally storing the updated parse in a second treebank data set.

2. The computer-implemented method of claim 1, further comprising, after accessing the digitally stored corpus data and tokenizing the corpus data into sequences of tokens, storing the sequences of tokens in persistent data storage as processed corpus data.

3. The computer-implemented method of claim 1, wherein the corpus data comprises a large-scale set of digitally stored natural language text organized at least in part in a plurality of sentences.

4. The computer-implemented method of claim 1, further comprising storing and managing during execution of the computer-implemented method, in the memory of the one or more computing devices, all of the sequences of tokens, possible POS sequences, candidate parses, and the updated parse.

5. The computer-implemented method of claim 1, further comprising training a constituency parser using the second treebank data set.

6. The computer-implemented method of claim 1, wherein the digitally stored corpus data comprises greater than 100,000 sentences.

7. The computer-implemented method of claim 1, wherein the digitally stored corpus data comprises WIKIPEDIA and the digitally stored lexical database comprises WORDNET.

8. One or more non-transitory computer-readable storage media storing one or more sequences of instructions which, when executed using one or more processors of a computer system, cause the one or more processors to execute:
accessing digitally stored corpus data and tokenizing the corpus data into sequences of tokens;
based on matching the sequences of tokens to a digitally stored part-of-speech (POS) dictionary, generating a plurality of POS sequences;
accessing a first treebank data set and storing a plurality of parses from the first treebank data set in a tree data structure in a memory of the computer system; and
for each POS sequence of the plurality of POS sequences:
using the tree data structure, identifying one or more candidate parses that match that POS sequence;
based on a digitally stored lexical database, selecting a sentence corresponding to one candidate parse of the one or more candidate parses that is most semantically similar to that POS sequence;
substituting, in the one candidate parse, words from that POS sequence, to form an updated parse; and
digitally storing the updated parse in a second treebank data set.

9. The one or more non-transitory computer-readable storage media of claim 8, further comprising sequences of instructions which, when executed using the one or more processors, cause the one or more processors to execute, after accessing the corpus data and tokenizing the corpus data into sequences of tokens, storing the sequences of tokens in persistent data storage as processed corpus data.

10. The one or more non-transitory computer-readable storage media of claim 8, wherein the corpus data comprises a large-scale set of digitally stored natural language text organized at least in part in a plurality of sentences.

11. The one or more non-transitory computer-readable storage media of claim 8, further comprising sequences of instructions which, when executed using the one or more processors, cause the one or more processors to execute storing and managing, in the memory of the one or more computing devices, all of the sequences of tokens, possible POS sequences, candidate parses, and the updated parse.

12. The one or more non-transitory computer-readable storage media of claim 8, further comprising sequences of instructions which, when executed using the one or more processors, cause the one or more processors to execute, before tokenizing the corpus data into sequences of tokens, accessing the digitally stored corpus data, deduplicating sentences in the corpus data, removing a plurality of one or more non-parseable sentence fragments from the corpus data, and updating the corpus data after the deduplicating and removing.

13. The one or more non-transitory computer-readable storage media of claim 8, further comprising sequences of instructions which, when executed using the one or more processors, cause the one or more processors to execute training a constituency parser using the second treebank data set.

14. The one or more non-transitory computer-readable storage media of claim 8,
wherein the digitally stored corpus data comprises WIKIPEDIA and the digitally stored lexical database comprises WORDNET.

15. A computer system, comprising:
one or more processors; and
one or more non-transitory computer-readable storage media storing one or more sequences of instructions which, when executed using the one or more processors, cause the one or more processors to execute:
accessing digitally stored corpus data and tokenizing the corpus data into sequences of tokens;
based on matching the sequences of tokens to a digitally stored part-of-speech (POS) dictionary, generating a plurality of POS sequences;
accessing a first treebank data set and storing a plurality of parses from the first treebank data set in a tree data structure in a memory of the computer system; and
for each POS sequence of the plurality of POS sequences:
using the tree data structure, identifying one or more candidate parses that match that POS sequence;
based on a digitally stored lexical database, selecting a sentence corresponding to one candidate parse of the one or more candidate parses that is most semantically similar to that POS sequence;
substituting, in the one candidate parse, words from that POS sequence, to form an updated parse; and
digitally storing the updated parse in a second treebank data set.

16. The computer system of claim 15, further comprising sequences of instructions which, when executed using one or more processors, cause the one or more processors to execute, after accessing the corpus data and tokenizing the corpus data into sequences of tokens, storing the sequences of tokens in persistent data storage as processed corpus data.

17. The computer system of claim 15, wherein the corpus data comprises a large-scale set of digitally stored natural language text organized at least in part in a plurality of sentences.

18. The computer system of claim 15, further comprising sequences of instructions which, when executed using one or more processors, cause the one or more processors to execute storing and managing, in the memory of the one or more computing devices, all of the sequences of tokens, possible POS sequences, candidate parses, and the updated parse.

19. The computer system of claim 15, further comprising sequences of instructions which, when executed using one or more processors, cause the one or more processors to execute, before tokenizing the corpus data into sequences of tokens, accessing the digitally stored corpus data, deduplicating sentences in the corpus data, removing a plurality of one or more non-parseable sentence fragments from the corpus data, and updating the corpus data after the deduplicating and removing.

20. The computer system of claim 15, further comprising sequences of instructions which, when executed using one or more processors, cause the one or more processors to execute training a constituency parser using the second treebank data set.

21. The computer system of claim 15, wherein the digitally stored corpus data comprises WIKIPEDIA and the digitally stored lexical database comprises WORDNET.
